(19) United States
(12) Patent Application Publication
(10) Pub. No.: US 2024/0394054 A1
(43) Pub. Date: Nov. 28, 2024

(54) SYSTEMS AND METHODS TO CREATE AN APPLICATION PROGRAM INTERFACE

(71) Applicant: Engineer.ai Corp., Salt Lake City, UT (US)

(72) Inventors: Sachin Dev Duggal, Salt Lake City, UT (US); Ustav Preet, London (GB); Rohan Patel, London (GB)

(73) Assignee: Engineer.ai Corp., Salt Lake City, UT (US)

(21) Appl. No.: 18/324,148

(22) Filed: May 25, 2023

(51) Int. Cl. G06F 8/77; G06F 9/54

(52) U.S. Cl. CPC G06F 8/77; G06F 9/54

(57) ABSTRACT

Method and System to create an Application Program Interface (API). The method includes receiving a request to develop the application from a customer and predicting a plurality of service categories required for the application development based on the received request. The method also includes recommending one or more service providers in each of the plurality of service categories based on the received request and creating the API for each of the recommended one or more service providers.

### FIELD OF THE INVENTION

This disclosure relates to software automation, machine learning AI, and project management.

### BACKGROUND

Users in an enterprise environment often need software applications to sell their products or services through digital platforms. The software applications once developed need to be integrated with one or more network-accessible services hosted by third parties so that the customer has a seamless experience of purchase of the products or services. For instance, the software application may include a feature to track orders from a customer end once orders are placed through the software application. In order to make the tracking of the orders, the software application needs to be integrated with third-party logistics services. Conventionally, users or owners of the software application are left to manually create an account in each of the third-party services by providing the required documents and provide login credentials to the developer associated with the software application to integrate the third-party services into the software application. However, the process of manual integration is time-consuming and tedious.

Accordingly, there is a need in the art for an enhanced process to integrate one or more services into the software application.

### SUMMARY

The disclosed subject matter includes systems, methods, and computer-readable storage mediums for recommending one or more external services for an application development. The method comprises receiving a request to develop the application from a customer and identifying one or more building blocks related to the development of the application based on the received request. The method further comprises recommending the one or more external services to be integrated to the application under development based on the identified one or more building blocks.

Another general aspect is a computer system to recommend one or more external services for an application development. The computer system includes a memory and a processor coupled to the memory. The processor is configured to receive a request to develop the application from a customer and identify one or more building blocks related to the development of the application based on the received request. The processor is further configured to recommend the one or more external services to be integrated to the application under development based on the identified one or more building blocks.

An exemplary embodiment is a computer readable storage medium having data stored therein representing software executable by a computer. The software includes instructions that, when executed, cause the computer readable storage medium to perform receiving a request to develop the application from a customer and identifying one or more building blocks related to the development of the application based on the received request. The instructions may further cause the computer readable storage medium to perform recommending the one or more external services to be integrated to the application under development based on the identified one or more building blocks.

Another general aspect is a method for creating an Application Program Interface (API). The method includes receiving a request to develop the application from a customer and predicting a plurality of service categories required for the application development based on the received request. The method also includes recommending one or more service providers in each of the plurality of service categories based on the received request and creating the API for each of the recommended one or more service providers.

An exemplary embodiment is a computer system to create an Application Program Interface (API). The computer system includes a memory and a processor coupled to the memory. The processor is configured to receive a request to develop the application from a customer and predict a plurality of service categories required for the application development based on the received request. The processor is also configured to recommend one or more service providers in each of the plurality of service categories based on the received request and create the API for each of the recommended one or more service providers.

Another general aspect is a computer readable storage medium having data stored therein representing software executable by a computer. The software includes instructions that, when executed, cause the computer readable storage medium to perform receiving a request to develop the application from a customer and predicting a plurality of service categories required for the application development based on the received request. The instructions may further cause the computer readable storage medium to perform recommending one or more service providers in each of the plurality of service categories based on the received request and creating the API for each of the recommended one or more service providers.

Another exemplary embodiment is a method for integrating one or more services to an application under development. The method includes receiving one or more inputs from a customer to develop the application and determining one or more service providers required for the application development based on the received one or more inputs. The method further includes creating a customer account for the determined one or more service providers and integrating the one or more services to the application under development using the customer account.

Another general aspect is a computer system to integrate one or more services to an application under development. The computer system includes a memory and a processor coupled to the memory. The processor is configured to receive one or more inputs from a customer to develop the application and determine one or more service providers required for the application development based on the received one or more inputs. The processor is also configured to create a customer account for the determined one or more service providers and integrate the one or more services to the application under development using the customer account.

An exemplary embodiment is a computer readable storage medium having data stored therein representing software executable by a computer. The software includes instructions that, when executed, cause the computer readable storage medium to perform receiving one or more inputs from a customer to develop the application and determining one or more service providers required for the application development based on the received one or more inputs. The instructions may further cause the computer readable storage medium to perform creating a customer account for the determined one or more service providers and integrating the one or more services to the application under development using the customer account.

The systems, methods, and computer readable storage of the present disclosure overcome one or more of the shortcomings of the prior art. Additional features and advantages may be realized through the techniques of the present disclosure. Other embodiments and aspects of the disclosure are described in detail herein and are considered a part of the claimed disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a software building system illustrating the components that may be used in an embodiment of the disclosed subject matter.

FIG. 2 is a schematic illustrating an embodiment of the management components of the disclosed subject matter.

FIG. 3 is a schematic illustrating an embodiment of an assembly line and surfaces of the disclosed subject matter.

FIG. 4 is a schematic illustrating an embodiment of the run entities of the disclosed subject matter.

FIG. 5 is a schematic diagram of an application development system in an embodiment of the disclosed subject matter.

FIG. 6 is a schematic diagram of an application development engine in an embodiment of the disclosed subject matter.

FIG. 7 is a flow diagram illustrating a method for recommending one or more external services for an application under development in an embodiment of the disclosed subject matter.

FIG. 8 is a flow diagram illustrating a method for creating a Application Program Interface (API) in an embodiment of the disclosed subject matter.

FIG. 9 is a flow diagram illustrating a method for integrating one or more services to an application under development in an embodiment of the disclosed subject matter.

FIG. 10 is a schematic illustrating the computing components that may be used to implement various features of embodiments described in the disclosed subject matter.

### DETAILED DESCRIPTION

The disclosed subject matter comprises systems, methods, and computer readable storage mediums for integrating one or more services to an application under development. The method includes receiving one or more inputs from a customer to develop the application and determining one or more service providers required for the application development based on the received one or more inputs. The method further includes creating a customer account for the determined one or more service providers and integrating the one or more services to the application under development using the customer account.

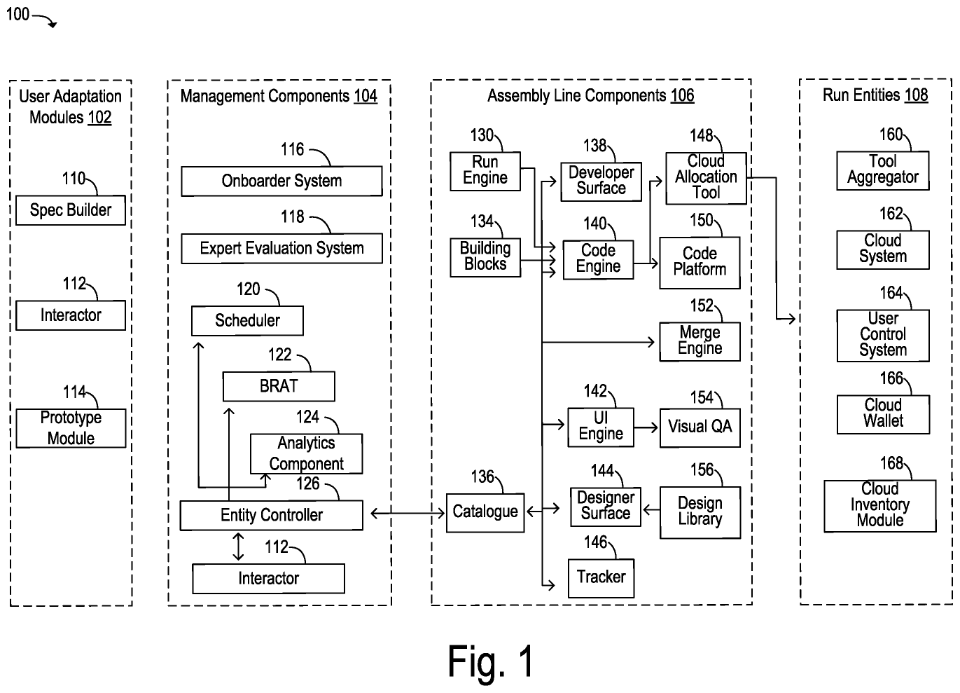

Referring to FIG. 1, FIG. 1 is a schematic of a software building system 100 illustrating the components that may be used in an embodiment of the disclosed subject matter. The software building system 100 is an AI-assisted platform that comprises entities, circuits, modules, and components that enable the use of state-of-the-art algorithms to support producing custom software.

A user may leverage the various components of the software building system 100 to quickly design and complete a software project. The features of the software building system 100 operate AI algorithms where applicable to streamline the process of building software. Designing, building and managing a software project may all be automated by the AI algorithms.

To begin a software project, an intelligent AI conversational assistant may guide users in conception and design of their idea. Components of the software building system 100 may accept plain language specifications from a user and convert them into a computer readable specification that can be implemented by other parts of the software building system 100. Various other entities of the software building system 100 may accept the computer readable specification or buildcard to automatically implement it and/or manage the implementation of the computer readable specification.

The embodiment of the software building system 100 shown in FIG. 1 includes user adaptation modules 102, management components 104, assembly line components 106, and run entities 108. The user adaptation modules 102 entities guide a user during all parts of a project from the idea conception to full implementation, user adaptation modules 102 may intelligently link a user to various entities of the software building system 100 based on the specific needs of the user.

The user adaptation modules 102 may include specification builder 110, an interactor 112 system, and the prototype module 114. They may be used to guide a user through a process of building software and managing a software project. Specification builder 110, the interactor 112 system, and the prototype module 114 may be used concurrently and/or link to one another. For instance, specification builder 110 may accept user specifications that are generated in an interactor 112 system. The prototype module 114 may utilize computer generated specifications that are produced in specification builder 110 to create a prototype for various features. Further, the interactor 112 system may aid a user in implementing all features in specification builder 110 and the prototype module 114.

Specification builder 110 converts user supplied specifications into specifications that can be automatically read and implemented by various objects, instances, or entities of the software building system 100. The machine readable specifications may be referred to herein as a buildcard. In an example of use, specification builder 110 may accept a set of features, platforms, etc., as input and generate a machine readable specification for that project. Specification builder 110 may further use one or more machine learning algorithms to determine a cost and/or timeline for a given set of features. In an example of use, specification builder 110 may determine potential conflict points and factors that will significantly affect cost and timeliness of a project based on training data. For example, historical data may show that a combination of various building block components create a data transfer bottleneck. Specification builder 110 may be configured to flag such issues.

The interactor 112 system is an AI powered speech and conversational analysis system. It converses with a user with a goal of aiding the user. In one example, the interactor 112 system may ask the user a question to prompt the user to answer about a relevant topic. For instance, the relevant topic may relate to a structure and/or scale of a software project the user wishes to produce. The interactor 112 system makes use of natural language processing (NLP) to decipher various forms of speech including comprehending words, phrases, and clusters of phases

In an exemplary embodiment, the NLP implemented by interactor 112 system is based on a deep learning algorithm. Deep learning is a form of a neural network where nodes are organized into layers. A neural network has a layer of input nodes that accept input data where each of the input nodes are linked to nodes in a next layer. The next layer of nodes after the input layer may be an output layer or a hidden layer. The neural network may have any number of hidden layers that are organized in between the input layer and output layers.

Data propagates through a neural network beginning at a node in the input layer and traversing through synapses to nodes in each of the hidden layers and finally to an output layer. Each synapse passes the data through an activation function such as, but not limited to, a Sigmoid function. Further, each synapse has a weight that is determined by training the neural network. A common method of training a neural network is backpropagation. Backpropagation is an algorithm used in neural networks to train models by adjusting the weights of the network to minimize the difference between predicted and actual outputs. During training, backpropagation works by propagating the error back through the network, layer by layer, and updating the weights in the opposite direction of the gradient of the loss function. By repeating this process over many iterations, the network gradually learns to produce more accurate outputs for a given input.

Various systems and entities of the software building system 100 may be based on a variation of a neural network or similar machine learning algorithm. For instance, input for NLP systems may be the words that are spoken in a sentence. In one example, each word may be assigned to separate input node where the node is selected based on the word order of the sentence. The words may be assigned various numerical values to represent word meaning whereby the numerical values propagate through the layers of the neural network.

The NLP employed by the interactor 112 system may output the meaning of words and phrases that are communicated by the user. The interactor 112 system may then use the NLP output to comprehend conversational phrases and sentences to determine the relevant information related to the user's goals of a software project. Further machine learning algorithms may be employed to determine what kind of project the user wants to build including the goals of the user as well as providing relevant options for the user.

The prototype module 114 can automatically create an interactive prototype for features selected by a user. For instance, a user may select one or more features and view a prototype of the one or more features before developing them. The prototype module 114 may determine feature links to which the user's selection of one or more features would be connected. In various embodiments, a machine learning algorithm may be employed to determine the feature links. The machine learning algorithm may further predict embeddings that may be placed in the user selected features.

An example of the machine learning algorithm may be a gradient boosting model. A gradient boosting model may use successive decision trees to determine feature links. Each decision tree is a machine learning algorithm in itself and includes nodes that are connected via branches that branch based on a condition into two nodes. Input begins at one of the nodes whereby the decision tree propagates the input down a multitude of branches until it reaches an output node. The gradient boosted tree uses multiple decision trees in a series. Each successive tree is trained based on errors of the previous tree and the decision trees are weighted to return best results.

The prototype module 114 may use a secondary machine learning algorithm to select a most likely starting screen for each prototype. Thus, a user may select one or more features and the prototype module 114 may automatically display a prototype of the selected features.

The software building system 100 includes management components 104 that aid the user in managing a complex software building project. The management components 104 allow a user that does not have experience in managing software projects to effectively manage multiple experts in various fields. An embodiment of the management components 104 include the onboarding system 116, an expert evaluation system 118, scheduler 120, BRAT 122, analytics component 124, entity controller 126, and the interactor 112 system.

The onboarding system 116 aggregates experts so they can be utilized to execute specifications that are set up in the software building system 100. In an exemplary embodiment, software development experts may register into the onboarding system 116 which will organize experts according to their skills, experience, and past performance. In one example, the onboarding system 116 provides the following features: partner onboarding, expert onboarding, reviewer assessments, expert availability management, and expert task allocation.

An example of partner onboarding may be pairing a user with one or more partners in a project. The onboarding system 116 may prompt potential partners to complete a profile and may set up contracts between the prospective partners. An example of expert onboarding may be a systematic assessment of prospective experts including receiving a profile from the prospective expert, quizzing the prospective expert on their skill and experience, and facilitating courses for the expert to enroll and complete. An example of reviewer assessments may be for the onboarding system 116 to automatically review completed portions of a project. For instance, the onboarding system 116 may analyze submitted code, validate functionality of submitted code, and assess a status of the code repository. An example of expert availability management in the onboarding system 116 is to manage schedules for expert assignments and oversee expert compensation. An example of expert task allocation is to automatically assign jobs to experts that are onboarded in the onboarding system 116. For instance, the onboarding system 116 may determine a best fit to match onboarded experts with project goals and assign appropriate tasks to the determined experts.

The expert evaluation system 118 continuously evaluates developer experts. In an exemplary embodiment, the expert evaluation system 118 rates experts based on completed tasks and assigns scores to the experts. The scores may provide the experts with valuable critique and provide the onboarding system 116 with metrics with it can use to allocate the experts on future tasks.

Scheduler 120 keeps track of overall progress of a project and provides experts with job start and job completion estimates. In a complex project, some expert developers may be required to wait until parts of a project are completed before their tasks can begin. Thus, effective time allocation can improve expert developer management. Scheduler 120 provides up to date estimates to expert developers for job start and completion windows so they can better manage their own time and position them to complete their job on time with high quality.

The big resource allocation tool (BRAT 122) is capable of generating optimal developer assignments for every available parallel workstream across multiple projects. BRAT 122 system allows expert developers to be efficiently managed to minimize cost and time. In an exemplary embodiment, the BRAT 122 system considers a plethora of information including feature complexity, developer expertise, past developer experience, time zone, and project affinity to make assignments to expert developers. The BRAT 122 system may make use of the expert evaluation system 118 to determine the best experts for various assignments. Further, the expert evaluation system 118 may be leveraged to provide live grading to experts and employ qualitative and quantitative feedback. For instance, experts may be assigned a live score based on the number of jobs completed and the quality of jobs completed.

The analytics component 124 is a dashboard that provides a view of progress in a project. One of many purposes of the analytics component 124 dashboard is to provide a primary form of communication between a user and the project developers. Thus, offline communication, which can be time consuming and stressful, may be reduced. In an exemplary embodiment, the analytics component 124 dashboard may show live progress as a percentage feature along with releases, meetings, account settings, and ticket sections. Through the analytics component 124 dashboard, dependencies may be viewed and resolved by users or developer experts.

The entity controller 126 is a primary hub for entities of the software building system 100. It connects to scheduler 120, the BRAT 122 system, and the analytics component 124 to provide for continuous management of expert developer schedules, expert developer scoring for completed projects, and communication between expert developers and users. Through the entity controller 126, both expert developers and users may assess a project, make adjustments, and immediately communicate any changes to the rest of the development team.

The entity controller 126 may be linked to the interactor 112 system, allowing users to interact with a live project via an intelligent AI conversational system. Further, the Interactor 112 system may provide expert developers with up-to-date management communication such as text. email, ticketing, and even voice communications to inform developers of expected progress and/or review of completed assignments.

The assembly line components 106 comprise underlying components that provide the functionality to the software building system 100. The embodiment of the assembly line components 106 shown in FIG. 1 includes a run engine 130, building block components 134, catalogue 136, developer surface 138, a code engine 140, a UI engine 142, a designer surface 144, tracker 146, a cloud allocation tool 148, a code platform 150, a merge engine 152, visual QA 154, and a design library 156.

The run engine 130 may maintain communication between various building block components within a project as well as outside of the project. In an exemplary embodiment, the run engine 130 may send HTTP/S GET or POST requests from one page to another.

The building block components 134 are reusable code that are used across multiple computer readable specifications. The term buildcards, as used herein, refer to machine readable specifications that are generated by specification builder 110, which may convert user specifications into a computer readable specification that contains the user specifications and a format that can be implemented by an automated process with minimal intervention by expert developers.

The computer readable specifications are constructed with building block components 134, which are reusable code components. The building block components 134 may be pretested code components that are modular and safe to use. In an exemplary embodiment, every building block component 134 consists of two sections—core and custom. Core sections comprise the lines of code which represent the main functionality and reusable components across computer readable specifications. The custom sections comprise the snippets of code that define customizations specific to the computer readable specification. This could include placeholder texts, theme, color, font, error messages, branding information, etc.

Catalogue 136 is a management tool that may be used as a backbone for applications of the software building system 100. In an exemplary embodiment, the catalogue 136 may be linked to the entity controller 126 and provide it with centralized, uniform communication between different services.

Developer surface 138 is a virtual desktop with preinstalled tools for development. Expert developers may connect to developer surface 138 to complete assigned tasks. In an exemplary embodiment, expert developers may connect to developer surface from any device connected to a network that can access the software project. For instance, developer experts may access developer surface 138 from a web browser on any device. Thus, the developer experts may essentially work from anywhere across geographic constraints. In various embodiments, the developer surface uses facial recognition to authenticate the developer expert at all times. In an example of use, all code that is typed by the developer expert is tagged with an authentication that is verified at the time each keystroke is made. Accordingly, if code is copied, the source of the copied code may be quickly determined. The developer surface 138 further provides a secure environment for developer experts to complete their assigned tasks.

The code engine 140 is a portion of a code platform 150 that assembles all the building block components required by the build card based on the features associated with the build card. The code platform 150 uses language-specific translators (LSTs) to generate code that follows a repeatable template. In various embodiments, the LSTs are pretested to be deployable and human understandable. The LSTs are configured to accept markers that identify the customization portion of a project. Changes may be automatically injected into the portions identified by the markers. Thus, a user may implement custom features while retaining product stability and reusability. In an example of use, new or updated features may be rolled out into an existing assembled project by adding the new or updated features to the marked portions of the LSTs.

In an exemplary embodiment, the LSTs are stateless and work in a scalable Kubernetes Job architecture which allows for limitless scaling that provide the needed throughput based on the volume of builds coming in through a queue system. This stateless architecture may also enable support for multiple languages in a plug & play manner.

The cloud allocation tool 148 manages cloud computing that is associated with computer readable specifications. For example, the cloud allocation tool 148 assesses computer readable specifications to predict a cost and resources to complete them. The cloud allocation tool 148 then creates cloud accounts based on the prediction and facilitates payments over the lifecycle of the computer readable specification.

The merge engine 152 is a tool that is responsible for automatically merging the design code with the functional code. The merge engine 152 consolidates styles and assets in one place allowing experts to easily customize and consume the generated code. The merge engine 152 may handle navigations that connect different screens within an application. It may also handle animations and any other interactions within a page.

The UI engine 142 is a design-to-code product that converts designs into browser ready code. In an exemplary embodiment, the UI engine 142 converts designs such as those made in Sketch into React code. The UI engine may be configured to scale generated UI code to various screen sizes without requiring modifications by developers. In an example of use, a design file may be uploaded by a developer expert to designer surface 144 whereby the UI engine automatically converts the design file into a browser ready format.

Visual QA 154 automates the process of comparing design files with actual generated screens and identifies visual differences between the two. Thus, screens generated by the UI engine 142 may be automatically validated by the visual QA 154 system. In various embodiments, a pixel to pixel comparison is performed using computer vision to identify discrepancies on the static page layout of the screen based on location, color contrast and geometrical diagnosis of elements on the screen. Differences may be logged as bugs by scheduler 120 so they can be reviewed by expert developers.

In an exemplary embodiment, visual QA 154 implements an optical character recognition (OCR) engine to detect and diagnose text position and spacing. Additional routines are then used to remove text elements before applying pixel-based diagnostics. At this latter stage, an approach based on similarity indices for computer vision is employed to check element position, detect missing/spurious objects in the UI and identify incorrect colors. Routines for content masking are also implemented to reduce the number of false positives associated with the presence of content in the UI such as dynamically changing text and/or images.

The visual QA 154 system may be used for computer vision, detecting discrepancies between developed screens, and designs using structural similarity indices. It may also be used for excluding dynamic content based on masking and removing text based on optical character recognition whereby text is removed before running pixel-based diagnostics to reduce the structural complexity of the input images.

The designer surface 144 connects designers to a project network to view all of their assigned tasks as well as create or submit customer designs. In various embodiments, computer readable specifications include prompts to insert designs. Based on the computer readable specification, the designer surface 144 informs designers of designs that are expected of them and provides for easy submission of designs to the computer readable specification. Submitted designs may be immediately available for further customization by expert developers that are connected to a project network.

Similar to building block components 134, the design library 156 contains design components that may be reused across multiple computer readable specifications. The design components in the design library 156 may be configured to be inserted into computer readable specifications, which allows designers and expert developers to easily edit them as a starting point for new designs. The design library 156 may be linked to the designer surface 144, thus allowing designers to quickly browse pretested designs for user and/or editing.

Tracker 146 is a task management tool for tracking and managing granular tasks performed by experts in a project network. In an example of use, common tasks are injected into tracker 146 at the beginning of a project. In various embodiments, the common tasks are determined based on prior projects, completed, and tracked in the software building system 100.

The run entities 108 contain entities that all users, partners, expert developers, and designers use to interact within a centralized project network. In an exemplary embodiment, the run entities 108 include tool aggregator 160, cloud system 162, user control system 164, cloud wallet 166, and a cloud inventory module 168. The tool aggregator 160 entity brings together all third-party tools and services required by users to build, run and scale their software project. For instance, it may aggregate software services from payment gateways and licenses such as Office 365. User accounts may be automatically provisioned for needed services without the hassle of integrating them one at a time. In an exemplary embodiment, users of the run entities 108 may choose from various services on demand to be integrated into their application. The run entities 108 may also automatically handle invoicing of the services for the user.

The cloud system 162 is a cloud platform that is capable of running any of the services in a software project. The cloud system 162 may connect any of the entities of the software building system 100 such as the code platform 150, developer surface 138, designer surface 144, catalogue 136, entity controller 126, specification builder 110, the interactor 112 system, and the prototype module 114 to users, expert developers, and designers via a cloud network. In one example, cloud system 162 may connect developer experts to an IDE and design software for designers allowing them to work on a software project from any device.

The user control system 164 is a system requiring the user to have input over every feature of a final product in a software product. With the user control system 164, automation is configured to allow the user to edit and modify any features that are attached to a software project regardless as to the coding and design by developer experts and designer. For example, building block components 134 are configured to be malleable such that any customizations by expert developers can be undone without breaking the rest of a project. Thus, dependencies are configured so that no one feature locks out or restricts development of other features.

Cloud wallet 166 is a feature that handles transactions between various individuals and/or groups that work on a software project. For instance, payment for work performed by developer experts or designers from a user is facilitated by cloud wallet 166. A user need only set up a single account in cloud wallet 166 whereby cloud wallet handles payments of all transactions.

A cloud allocation tool 148 may automatically predict cloud costs that would be incurred by a computer readable specification. This is achieved by consuming data from multiple cloud providers and converting it to domain specific language, which allows the cloud allocation tool 148 to predict infrastructure blueprints for customers' computer readable specifications in a cloud agnostic manner. It manages the infrastructure for the entire lifecycle of the computer readable specification (from development to after care) which includes creation of cloud accounts, in predicted cloud providers, along with setting up CI/CD to facilitate automated deployments.

The cloud inventory module 168 handles storage of assets on the run entities 108. For instance, building block components 134 and assets of the design library are stored in the cloud inventory entity. Expert developers and designers that are onboarded by onboarding system 116 may have profiles stored in the cloud inventory module 168. Further, the cloud inventory module 168 may store funds that are managed by the cloud wallet 166. The cloud inventory module 168 may store various software packages that are used by users, expert developers, and designers to produce a software product.

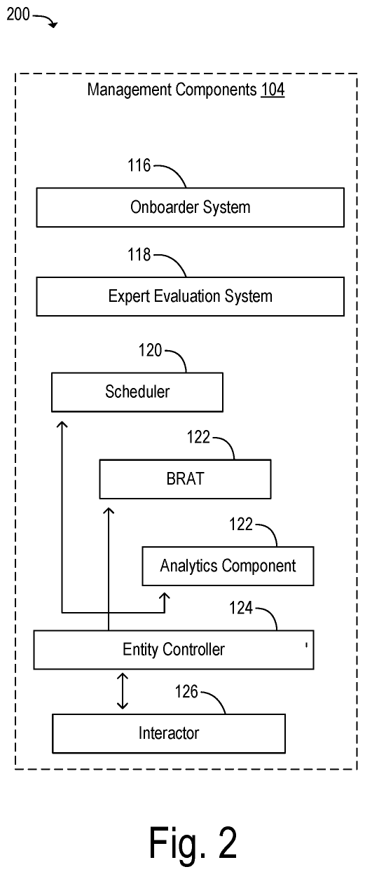

Referring to FIG. 2, FIG. 2 is a schematic 200 illustrating an embodiment of the management components 104 of the software building system 100. The management components 104 provide for continuous assessment and management of a project through its entities and systems. The central hub of the management components 104 is entity controller 126. In an exemplary embodiment, core functionality of the entity controller 126 system comprises the following: display computer readable specifications configurations, provide statuses of all computer readable specifications, provide toolkits within each computer readable specification, integration of the entity controller 126 with tracker 146 and the onboarding system 116, integration code repository for repository creation, code infrastructure creation, code management, and expert management, customer management, team management, specification and demonstration call booking and management, and meetings management.

In an exemplary embodiment, the computer readable specification configuration status includes customer information, requirements, and selections. The statuses of all computer readable specifications may be displayed on the entity controller 126, which provides a concise perspective of the status of a software project. Toolkits provided in each computer readable specification allow expert developers and designers to chat, email, host meetings, and implement 3rd party integrations with users. Entity controller 126 allows a user to track progress through a variety of features including but not limited to tracker 146, the UI engine 142, and the onboarding system 116. For instance, the entity controller 126 may display the status of computer readable specifications as displayed in tracker 146. Further, the entity controller 126 may display a list of experts available through the onboarding system 116 at a given time as well as ranking experts for various jobs.

The entity controller 126 may also be configured to create code repositories. For example, the entity controller 126 may be configured to automatically create an infrastructure for code and to create a separate code repository for each branch of the infrastructure. Commits to the repository may also be managed by the entity controller 126.

Entity controller 126 may be integrated into scheduler 120 to determine a timeline for jobs to be completed by developer experts and designers. The BRAT 122 system may be leveraged to score and rank experts for jobs in scheduler 120. A user may interact with the various entity controller 126 features through the analytics component 124 dashboard. Alternatively, a user may interact with the entity controller 126 features via the interactive conversation in the interactor 112 system.

Entity controller 126 may facilitate user management such as scheduling meetings with expert developers and designers, documenting new software such as generating an API, and managing dependencies in a software project. Meetings may be scheduled with individual expert developers, designers, and with whole teams or portions of teams.

Machine learning algorithms may be implemented to automate resource allocation in the entity controller 126. In an exemplary embodiment, assignment of resources to groups may be determined by constrained optimization by minimizing total project cost. In various embodiments a health state of a project may be determined via probabilistic Bayesian reasoning whereby a causal impact of different factors on delays using a Bayesian network are estimated.

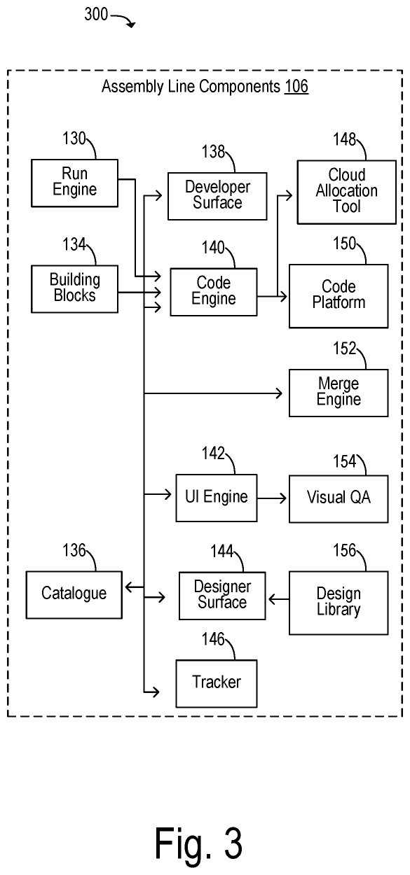

Referring to FIG. 3, FIG. 3 is a schematic 300 illustrating an embodiment of the assembly line components 106 of the software building system 100. The assembly line components 106 support the various features of the management components 104. For instance, the code platform 150 is configured to facilitate user management of a software project. The code engine 140 allows users to manage the creation of software by standardizing all code with pretested building block components. The building block components contain LSTs that identify the customizable portions of the building block components 134.

The machine readable specifications may be generated from user specifications. Like the building block components, the computer readable specifications are designed to be managed by a user without software management experience. The computer readable specifications specify project goals that may be implemented automatically. For instance, the computer readable specifications may specify one or more goals that require expert developers. The scheduler 120 may hire the expert developers based on the computer readable specifications or with direction from the user. Similarly, one or more designers may be hired based on specifications in a computer readable specification. Users may actively participate in management or take a passive role.

A cloud allocation tool 148 is used to determine costs for each computer readable specification. In an exemplary embodiment, a machine learning algorithm is used to assess computer readable specifications to estimate costs of development and design that is specified in a computer readable specification. Cost data from past projects may be used to train one or more models to predict costs of a project.

The developer surface 138 system provides an easy to set up platform within which expert developers can work on a software project. For instance, a developer in any geography may connect to a project via the cloud system 162 and immediately access tools to generate code. In one example, the expert developer is provided with a preconfigured IDE as they sign into a project from a web browser.

The designer surface 144 provides a centralized platform for designers to view their assignments and submit designs. Design assignments may be specified in computer readable specifications. Thus, designers may be hired and provided with instructions to complete a design by an automated system that reads a computer readable specification and hires out designers based on the specifications in the computer readable specification. Designers may have access to pretested design components from a design library 156. The design components, like building block components, allow the designers to start a design from a standardized design that is already functional.

The UI engine 142 may automatically convert designs into web ready code such as React code that may be viewed by a web browser. To ensure that the conversion process is accurate, the visual QA 154 system may evaluate screens generated by the UI engine 142 by comparing them with the designs that the screens are based on. In an exemplary embodiment, the visual QA 154 system does a pixel to pixel comparison and logs any discrepancies to be evaluated by an expert developer.

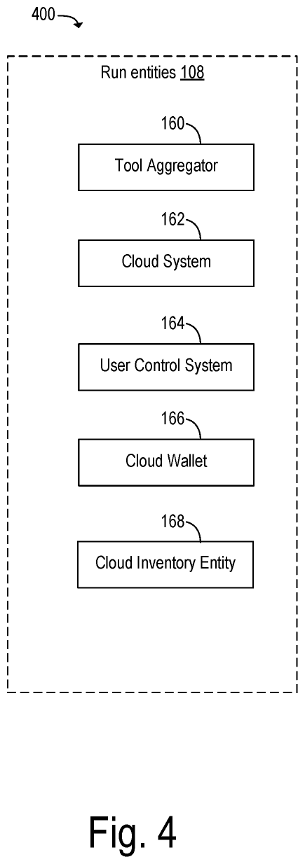

Referring to FIG. 4, FIG. 4 is a schematic 400 illustrating an embodiment of the run entities 108 of the software building system. The run entities 108 provides a user with 3^{rd} party tools and services, inventory management, and cloud services in a scalable system that can be automated to manage a software project. In an exemplary embodiment, the run entities 108 is a cloud-based system that provides a user with all tools necessary to run a project in a cloud environment.

For instance, the tool aggregator 160 automatically subscribes with appropriate 3^{rd} party tools and services and makes them available to a user without a time consuming and potentially confusing set up. The cloud system 162 connects a user to any of the features and services of the software project through a remote terminal. Through the cloud system 162, a user may use the user control system 164 to manage all aspects of a software project including conversing with an intelligent Al in the interactor 112 system, providing user specifications that are converted into computer readable specifications, providing user designs, viewing code, editing code, editing designs, interacting with expert developers and designers, interacting with partners, managing costs, and paying contractors.

A user may handle all costs and payments of a software project through cloud wallet 166. Payments to contractors such as expert developers and designers may be handled through one or more accounts in cloud wallet 166. The automated systems that assess completion of projects such as tracker 146 may automatically determine when jobs are completed and initiate appropriate payment as a result. Thus, accounting through cloud wallet 166 may be at least partially automated. In an exemplary embodiment, payments through cloud wallet 166 are completed by a machine learning AI that assesses job completion and total payment for contractors and/or employees in a software project.

Cloud inventory module 168 automatically manages inventory and purchases without human involvement. For example, cloud inventory module 168 manages storage of data in a repository or data warehouse. In an exemplary embodiment, it uses a modified version of the knapsack algorithm to recommend commitments to data that it stores in the data warehouse. Cloud inventory module 168 further automates and manages cloud reservations such as the tools providing in the tool aggregator 160.

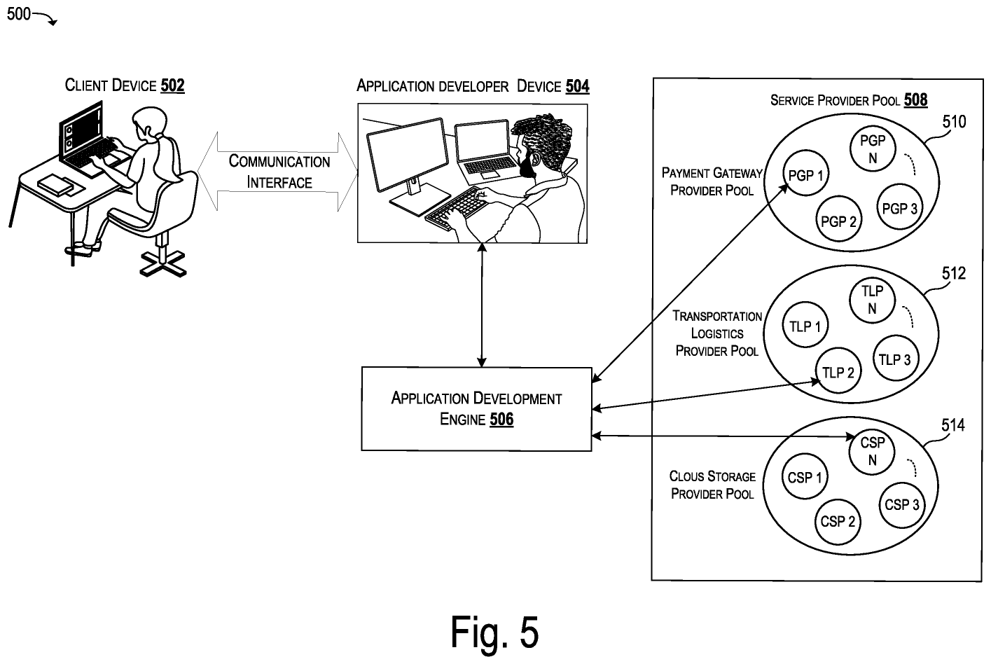

Referring to FIG. 5, FIG. 5 is a schematic diagram of an application development system 500 in an embodiment of the disclosed subject matter. In an exemplary embodiment, the application development system 500 comprises a client device 502, an application developer device 504, an application development engine 506 coupled to the application developer device 504, and a service provider pool 508. The client is configured to provide one or more inputs or request to develop an application to the application development engine 506 by communicating with the application developer device 504 through the client device 502. The request to develop the application includes details of the application to be developed. In one embodiment, the details can be one or more features and a timeline to develop the application.

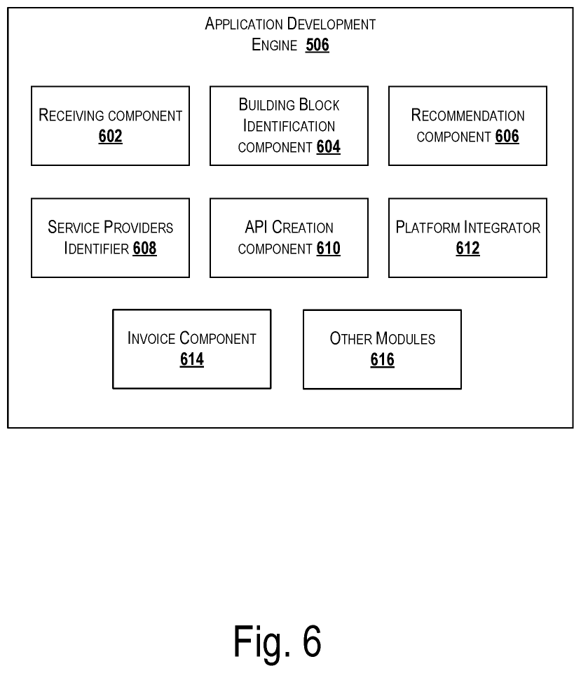

Upon receiving the request to develop the application, the application development engine 506 performs one or more functions and communicates with the service provider pool 508. The service provider pool includes one or more service providers in each category. For example, as shown in FIG. 5, the service provider pool 508 includes a payment gateway providers pool 510, a transportation logistics provider pool 512, and a cloud storage providers pool 514. Each of the payment gateway provider pool 510, the transportation logistics provider pool 512, and the cloud storage provider pool 514 include one or more service providers in their respective categories. For example, the payment gateway provider pool 510 includes a payment gateway provider (PGP) 1, PGP 2, PGP 3, and so on. Similarly, the transportation logistics provider pool 512 includes a transportation logistics provider (TLP) 1, TLP 2, TLP 3, and so on. Similarly, the cloud storage provider pool 514 includes a cloud storage provider (CSP) 1, CSP 2, CSP 3, and so on. The application development engine 506 interaction with the service provider pool 508 for the development of the entire application as requested by the client will be explained further with respect to FIG. 6.

Referring to FIG. 6, FIG. 6 is a schematic diagram of the application development engine 506 in an embodiment of the disclosed subject matter. The application development engine 506 is configured to manage the entire life cycle of the application development.

The application development engine 506 comprises one or more components coupled with each other that may be deployed on a single system or different system. In an embodiment, the application development engine 506 comprises a receiving component 602, a building block identification component 604, a recommendation component 606, a service provider identifier 608, a API creator component 610, a platform integrator 612, an Invoice component 614, and other modules 616.

As used herein, the term module or component refers to an application-specific integrated circuit (ASIC), an electronic circuit, a processor (shared, dedicated, or group) and memory that execute one or more software or firmware programs, a combinational logic circuit, and/or other suitable components that provide the described functionality. In an embodiment, the other modules 616 may be used to perform various miscellaneous functionalities of the application development engine 506. It will be appreciated that such modules 616 may be represented as a single module or a combination of different modules.

In an embodiment, the receiving component 602 is configured to receive a request to develop the application from a customer or the client. The request to develop the application includes details of the application to be developed. In one embodiment, the details include one or more features of the application and a timeline for the development of the application. In another embodiment, the receiving component 602 is configured to receive receiving one or more inputs to develop the application from the customer. The one or more inputs to develop the application includes details of the application to be developed. In one embodiment, the details include one or more features of the application and a timeline for the development of the application.

The building block identification component 604 is configured to identify one or more building blocks related to the development of the application based on the received request by the receiving component 602. In order to identify the one or more building blocks related to the development of the application, the building block identification component 604 is configured to determine one or more core features for the development of the application based on the received request and predict one or more essential features related to the application based on the determined one or more core features. In one embodiment, the one or more core features are the mandatory features based on the request received from the customer and the one or more essential features are the non-mandatory but required feature for the completeness of the application. For example, when the application is getting developed for e-commerce, the core features are a product list feature and an order completion feature. The essential features are a payment gateway provider integration feature and a transportation logistics provider integration feature to take care of the completeness of the order. In one embodiment, the building block identification component 604 is configured to determine the one or more core features by inputting the request from the customer to a Natural Language Processing (NLP) model. In another embodiment, the building block identification component 604 is configured to predict the one or more essential features related to the application by inputting the determined one or more essential features and historical data to a machine learning model, where the historical data include data related to one or more applications developed previously. In one embodiment, the historical data is stored in a graph database.

Further, upon determining the one or more core features and predicting the one or more essential features, the building block identification component 604 is configured to identify the one or more building blocks related to the development of the application based on the determined one or more core features and the predicted one or more essential features.

The recommendation component 606 is configured to recommend the one or more external services to be integrated to the application under development based on the identified one or more building blocks. In one embodiment, in order to recommend the one or more external services, the recommendation component 606 is configured to identify one or more preferences of the customer from multiple sources and filter the identified one or more building blocks based on the identified one or more preferences of the customer. In one embodiment, the multiple sources include at least one of a transcribed text from a meeting, a recurring meeting pattern, an email message, an instant message, a text message, a voicemail message, and a video chat. Further, upon filtering the one or more building blocks, the recommendation component 606 is configured to recommend the one or more external services to be integrated based on the filtered one or more building blocks. The one or more external services are services hosted by third parties (e.g., payment gateway services, logistics services, and so on) so that the customer has a seamless experience of purchase of the products or services using the software application developed.

The service provider identifier 608 is configured to predict a plurality of service categories required for the application development based on the received request. As shown in FIG. 5, the plurality of service categories includes the payment gateway providers pool 510, the transportation logistics provider pool 512, and the cloud storage providers pool 514. In order to predict the plurality of service categories, the service provider identifier 608 is configured to input the request from the customer to a Natural Language Processing (NLP) model to identify a plurality of inputs and process the plurality of inputs and historical data to a machine learning model. Further, the service provider identifier 608 is configured to predict the plurality of service categories required for the application development based on an output of the machine learning model.

The recommendation component 606 is further configured to recommend one or more service providers in each of the plurality of service categories based on the received request. In order to recommend the one or more service providers, the recommendation component 606 is configured to identify a customer profile using one or more sources, wherein the customer profile includes a location of the customer, a financial rating of the customer, and other details of the customer. Further, the recommendation component 606 is configured to process the customer profile and historical data to a machine learning model and recommend the one or more service providers in each of the plurality of service categories based on an output of the machine learning model. In one embodiment, the one or more service providers are third-party service providers which are available for the customer and that can be integrated for the software application being developed.

The API creator 610 is configured to create the API for each of the recommended one or more service providers. In order to create the API, the API creator 610 is configured to retrieve the customer profile from a database and estimate one or more input fields based on the retrieved customer profile and the recommended one or more service providers. Further, the API creator 610 is configured to create the API based on the estimated one or more input fields.

The platform integrator 612 is configured to send a request to the recommended one or more service providers via the created API. In one embodiment, the request to the recommended one or more service providers is sent to create an account for the customer in the recommended one or more service providers. The platform integrator 612 is then configured to create the customer account for the determined one or more service providers based on the request sent. In one embodiment, creating the customer account comprises retrieving login credentials received from each of the determined one or more service providers. In one embodiment, the platform integrator 612 is configured to integrate the one or more services to the application under development using the customer account. In order to integrate the one or more services, the platform integrator 612 is configured to retrieve one or more building blocks related to the one or more services from a plurality of building blocks related to the application under development and integrate the one or more services to the application under development by injecting the retrieved login credentials to the retrieved one or more building blocks.

In another embodiment, the platform integrator 612 is configured to integrate the one or more recommended service providers in the application under development using the customer account created at the recommended one or more service providers.

The invoice component 614 is configured to retrieve one or more documents related to each of the integrated one or more service providers and generate at least one consolidated document for the customer based on the retrieved one or more documents.

The application development engine 506 may also comprise the other modules 616 to perform various miscellaneous functionalities of the application development engine 506. It will be appreciated that such aforementioned modules may be represented as a single module or a combination of different modules. The modules may be implemented in the form of software implemented by a processor, hardware and or firmware.

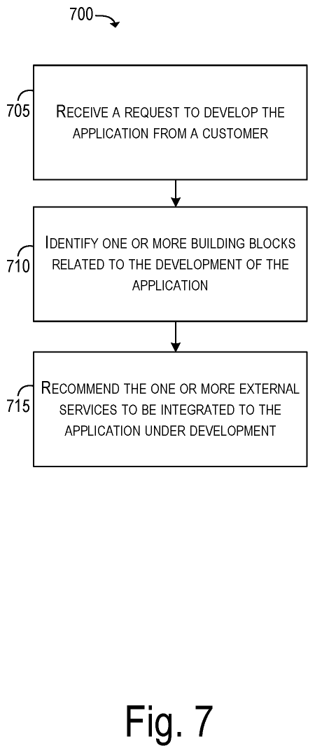

Referring to FIG. 7, FIG. 7 is a flow diagram 700 for an embodiment of a process of recommending one or more external services for an application development. The process may be utilized by one or more modules or components in the application development engine 506 for recommending one or more external services for an application development. The order in which the process/method 700 is described is not intended to be construed as a limitation, and any number of the described method blocks can be combined in any order to implement the method 700. Additionally, individual blocks may be deleted from the method 700 without departing from the spirit and scope of the subject matter described herein. Furthermore, the method 700 can be implemented in any suitable hardware, software, firmware, or combination thereof.

At step 705, the process may receive a request to develop a software application from a customer. In an embodiment, the receiving component 602 is configured to receive a request to develop the application from a customer or the client. The request to develop the application includes details of the application to be developed. In one embodiment, the details include one or more features of the application and a timeline for the development of the application.

At step 710, the process may identify one or more building blocks related to the development of the application. The building block identification component 604 is configured to identify one or more building blocks related to the development of the application based on the received request by the receiving component 602. In order to identify the one or more building blocks related to the development of the application, the building block identification component 604 is configured to determine one or more core features for the development of the application based on the received request and predict one or more essential features related to the application based on the determined one or more core features. In one embodiment, the one or more core features are the mandatory features based on the request received from the customer and the one or more essential features are the non-mandatory but required feature for the completeness of the application. For example, when the application is getting developed for e-commerce, the core features are a product list feature and an order completion feature. The essential features are a payment gateway provider integration feature and a transportation logistics provider integration feature to take care of the completeness of the order. In one embodiment, the building block identification component 604 is configured to determine the one or more core features by inputting the request from the customer to a Natural Language Processing (NLP) model. In another embodiment, the building block identification component 604 is configured to predict the one or more essential features related to the application by inputting the determined one or more essential features and historical data to a machine learning model, where the historical data include data related to one or more applications developed previously. In one embodiment, the historical data is stored in a graph database. Further, upon determining the one or more core features and predicting the one or more essential features, the building block identification component 604 is configured to identify the one or more building blocks related to the development of the application based on the determined one or more core features and the predicted one or more essential features.

At step 715, the process may recommend the one or more external services to be integrated to the application under development based on the identified one or more building blocks. The recommendation component 606 is configured to recommend the one or more external services to be integrated to the application under development based on the identified one or more building blocks. In one embodiment, in order to recommend the one or more external services, the recommendation component 606 is configured to identify one or more preferences of the customer from multiple sources and filter the identified one or more building blocks based on the identified one or more preferences of the customer. In one embodiment, the multiple sources include at least one of a transcribed text from a meeting, a recurring meeting pattern, an email message, an instant message, a text message, a voicemail message, and a video chat. Further, upon filtering the one or more building blocks, the recommendation component 606 is configured to recommend the one or more external services to be integrated based on the filtered one or more building blocks.

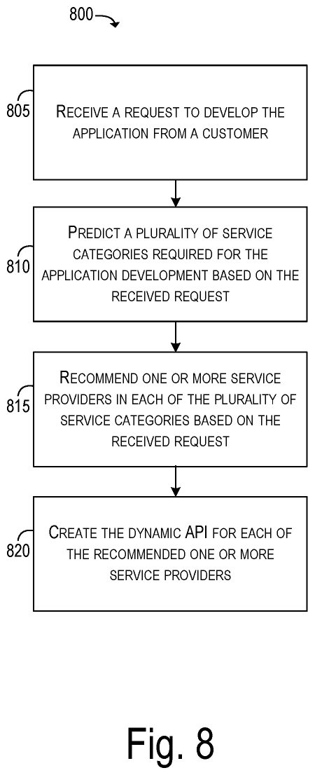

Referring to FIG. 8, FIG. 8 is a flow diagram 800 for an embodiment of a process of creating a Application Program Interface (API). The process may be utilized by one or more modules or components in the application development engine 520 for creating the Application Program Interface (API). The order in which the process/method 800 is described is not intended to be construed as a limitation, and any number of the described method blocks can be combined in any order to implement the method 800. Additionally, individual blocks may be deleted from the method 800 without departing from the spirit and scope of the subject matter described herein. Furthermore, the method 800 can be implemented in any suitable hardware, software, firmware, or combination thereof.

At step 805, the process may receive a request to develop the application from a customer. In an embodiment, the receiving component 602 is configured to receive receiving a request to develop the application from a customer or the client. The request to develop the application includes details of the application to be developed. In one embodiment, the details include one or more features of the application and a timeline for the development of the application.

At step 810, the process may predict a plurality of service categories required for the application development based on the received request. The service provider identifier 608 is configured to predict a plurality of service categories required for the application development based on the received request. As shown in FIG. 5, the plurality of service categories includes the payment gateway providers pool 510, the transportation logistics provider pool 512, and the cloud storage providers pool 514. In order to predict the plurality of service categories, the service provider identifier 608 is configured to input the request from the customer to a Natural Language Processing (NLP) model to identify a plurality of inputs and process the plurality of inputs and historical data to a machine learning model. Further, the service provider identifier 608 is configured to predict the plurality of service categories required for the application development based on an output of the machine learning model.

At step 815, the process may recommend one or more service providers in each of the plurality of service categories based on the received request. The recommendation component 606 is further configured to recommend one or more service providers in each of the plurality of service categories based on the received request. In order to recommend the one or more service providers, the recommendation component 606 is configured to identify a customer profile using one or more sources, wherein the customer profile includes a location of the customer, a financial rating of the customer, and other details of the customer. Further, the recommendation component 606 is configured to process the customer profile and historical data to a machine learning model and recommend the one or more service providers in each of the plurality of service categories based on an output of the machine learning model.

At step 820, the process may create the API for each of the recommended one or more service providers. The API creator 610 is configured to create the API for each of the recommended one or more service providers. In order to create the API, the API creator 610 is configured to retrieve the customer profile from a database and estimate one or more input fields based on the retrieved customer profile and the recommended one or more service providers. Further, the API creator 610 is configured to create the API based on the estimated one or more input fields.

In an embodiment, upon creating the API, a request is sent to the recommended one or more service providers via the created API. In one exemplary embodiment, the request to the recommended one or more service providers is sent by encrypting information included in the API. Further, upon receiving customer account details from the recommended one or more service providers, the platform integrator 612 is configured to integrate the one or more recommended service providers in the application under development using the customer account created at the recommended one or more service providers. Further, the invoice component 614 is configured to retrieve one or more documents related to each of the integrated one or more service providers and generate at least one consolidated document for the customer based on the retrieved one or more documents.

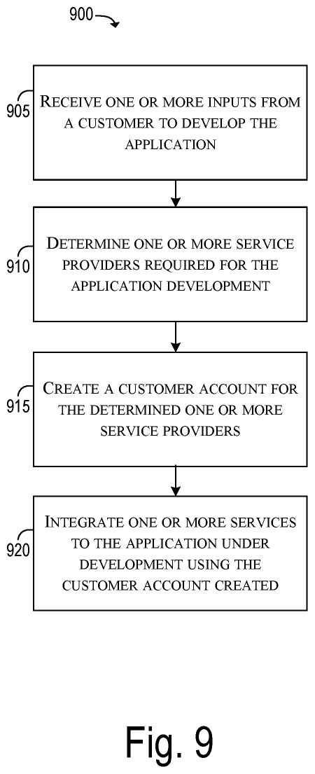

Referring to FIG. 9, FIG. 9 is a flow diagram 900 for an embodiment of a process of integrating one or more services to an application under development. The process may be utilized by one or more modules or components in the application development engine 520 for integrating one or more services to an application under development. The order in which the process/method 900 is described is not intended to be construed as a limitation, and any number of the described method blocks can be combined in any order to implement the method 900. Additionally, individual blocks may be deleted from the method 900 without departing from the spirit and scope of the subject matter described herein. Furthermore, the method 900 can be implemented in any suitable hardware, software, firmware, or combination thereof.

At step 905, the process may receive one or more inputs from a customer to develop the application. The receiving component 602 is configured to receive receiving one or more inputs to develop the application from the customer. The one or more inputs to develop the application includes details of the application to be developed. In one embodiment, the details include one or more features of the application and a timeline for the development of the application.

At step 910, the process may determine one or more service providers required for the application development based on the received one or more inputs. The recommendation component 606 is configured to predict one or more essential features related to the application based on the one or more cores features and determine the one or more service providers required for the application development based on the predicted one or more essential features.

At step 915, the process may create a customer account for the determined one or more service providers. The API creator 610 is configured to create the API for each of the recommended one or more service providers. In order to create the API, the API creator 610 is configured to retrieve the customer profile from a database and estimate one or more input fields based on the retrieved customer profile and the recommended one or more service providers. Further, the API creator 610 is configured to create the API based on the estimated one or more input fields. The platform integrator 612 is configured to send a request to the recommended one or more service providers via the created API. In one embodiment, the request to the recommended one or more service providers is sent to create an account for the customer in the recommended one or more service providers. The platform integrator 612 is then configured to creating the customer account for the determined one or more service providers based on the request sent. In one embodiment, creating the customer account comprises retrieving login credentials received from each of the determined one or more service providers.

At step 920, the process may integrate the one or more services to the application under development using the customer account. In one embodiment, the platform integrator 612 is configured to integrate the one or more services to the application under development using the customer account. In order to integrate the one or more services, the platform integrator 612 is configured to retrieve one or more building blocks related to the one or more services from a plurality of building blocks related to the application under development and integrate the one or more services to the application under development by injecting the retrieved login credentials to the retrieved one or more building blocks. In another embodiment, the platform integrator 612 is configured to integrate the one or more recommended service providers in the application under development using the customer account created at the recommended one or more service providers.

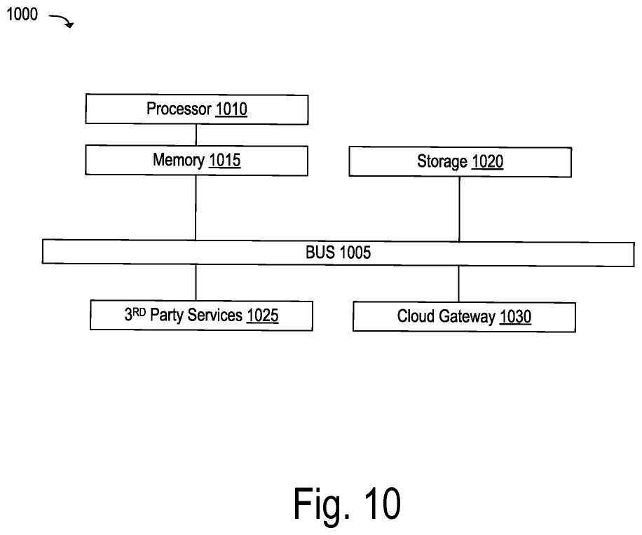

Referring to FIG. 10, FIG. 10 is a schematic illustrating a computing system 1000 that may be used to implement various features of embodiments described in the disclosed subject matter. The terms components, entities, modules, surface, and platform, when used herein, may refer to one of the many embodiments of a computing system 1000. The computing system 1000 may be a single computer, a co-located computing system, a cloud-based computing system, or the like. The computing system 1000 may be used to carry out the functions of one or more of the features, entities, and/or components of a software project.

The exemplary embodiment of the computing system 1000 shown in FIG. 10 includes a bus 1005 that connects the various components of the computing system 1000, one or more processors 1010 connected to a memory 1015, and at least one storage 1020. The processor 1010 is an electronic circuit that executes instructions that are passed to it from the memory 1015. Executed instructions are passed back from the processor 1010 to the memory 1015. The interaction between the processor 1010 and memory 1015 allow the computing system 1000 to perform computations, calculations, and various computing to run software applications.

Examples of the processor 1010 include central processing units (CPUs), graphics processing units (GPUs), field programmable gate arrays (FPGAs), complex programmable logic devices (CPLDs), and application specific integrated circuits (ASICs). The memory 1015 stores instructions that are to be passed to the processor 1010 and receives executed instructions from the processor 1010. The memory 1015 also passes and receives instructions from all other components of the computing system 1000 through the bus 1005. For example, a computer monitor may receive images from the memory 1015 for display. Examples of memory include random access memory (RAM) and read only memory (ROM). RAM has high speed memory retrieval and does not hold data after power is turned off. ROM is typically slower than RAM and does not lose data when power is turned off.

The storage 1020 is intended for long term data storage. Data in the software project such as computer readable specifications, code, designs, and the like may be saved in a storage 1020. The storage 1020 may be stored at any location including in the cloud. Various types of storage include spinning magnetic drives and solid-state storage drives.

The computing system 1000 may connect to other computing systems in the performance of a software project. For instance, the computing system 1000 may send and receive data from 3^{rd} party services such as Office 365 and Adobe. Similarly, users may access the computing system 1000 via a cloud gateway 1030. For instance, a user on a separate computing system may connect to the computing system 1000 to access data, interact with the run entities 108, and even use 3^{rd} party services 1025 via the cloud gateway.

Many variations may be made to the embodiments of the software project described herein. All variations, including combinations of variations, are intended to be included within the scope of this disclosure. The description of the embodiments herein can be practiced in many ways. Any terminology used herein should not be construed as restricting the features or aspects of the disclosed subject matter. The scope should instead be construed in accordance with the appended claims.

We claim:

1. A method for creating an Application Program Interface (API), the method comprising:
receiving a request to develop the application from a customer;
predicting a plurality of service categories required for the application development based on the received request;
recommending one or more service providers in each of the plurality of service categories based on the received request; and
creating the API for each of the recommended one or more service providers.

2. The method of claim 1, wherein predicting the plurality of service categories required for the application development based on the received request comprises:
inputting the request from the customer to a Natural Language Processing (NLP) model to identify a plurality of inputs;
processing the plurality of inputs and historical data to a machine learning model; and
predicting the plurality of service categories required for the application development based on an output of the machine learning model.

3. The method of claim 1, wherein recommending the one or more service providers in each of the plurality of service categories comprises:
identifying a customer profile using one or more sources, wherein the customer profile includes a location of the customer, a financial rating of the customer, and other details of the customer;
processing the customer profile and historical data to a machine learning model; and
recommending the one or more service providers in each of the plurality of service categories based on an output of the machine learning model.

4. The method of claim 3, wherein creating the API for each of the recommended one or more service providers comprises:
retrieving the customer profile from a database;
estimating one or more input fields based on the retrieved customer profile and the recommended one or more service providers; and
creating the API based on the estimated one or more input fields.

5. The method of claim 1, further comprises sending a request to the recommended one or more service providers via the created API, wherein the request to the recommended one or more service providers is sent to create an account for the customer in the recommended one or more service providers.

6. The method of claim 5, further comprises:
integrating the one or more recommended service providers in the application under development using the customer account created at the recommended one or more service providers;
retrieving one or more documents related to each of the integrated one or more service providers; and
generating at least one consolidated document for the customer based on the retrieved one or more documents.

7. The method of claim 5, wherein the request to the recommended one or more service providers is sent by encrypting information included in the API.

8. A system to create a Application Program Interface (API), the system comprises:
a memory; and
a processor, coupled to the memory, and configured to:
receiving a request to develop the application from a customer;
predicting a plurality of service categories required for the application development based on the received request;
recommending one or more service providers in each of the plurality of service categories based on the received request; and
creating the API for each of the recommended one or more service providers.

9. The system of claim 8, wherein predicting the plurality of service categories required for the application development based on the received request comprises:
inputting the request from the customer to a Natural Language Processing (NLP) model to identify a plurality of inputs;
processing the plurality of inputs and historical data to a machine learning model; and
predicting the plurality of service categories required for the application development based on an output of the machine learning model.

10. The system of claim 8, wherein recommending the one or more service providers in each of the plurality of service categories comprises:
identifying a customer profile using one or more sources, wherein the customer profile includes a location of the customer, a financial rating of the customer, and other details of the customer;
processing the customer profile and historical data to a machine learning model; and
recommending the one or more service providers in each of the plurality of service categories based on an output of the machine learning model.

11. The system of claim 10, wherein creating the API for each of the recommended one or more service providers comprises:
retrieving the customer profile from a database;
estimating one or more input fields based on the retrieved customer profile and the recommended one or more service providers; and
creating the API based on the estimated one or more input fields.

12. The system of claim 8, further comprises sending a request to the recommended one or more service providers via the created API, wherein the request to the recommended one or more service providers is sent to create an account for the customer in the recommended one or more service providers.

13. The system of claim 12, further comprises:
integrating the one or more recommended service providers in the application under development using the customer account created at the recommended one or more service providers;
retrieving one or more documents related to each of the integrated one or more service providers; and
generating at least one consolidated document for the customer based on the retrieved one or more documents.

14. The system of claim 12, wherein the request to the recommended one or more service providers is sent by encrypting information included in the API.

15. A computer readable storage medium having data stored therein representing software executable by a computer, the software comprising instructions that, when executed, cause the computer readable storage medium to perform:
receiving a request to develop the application from a customer;
predicting a plurality of service categories required for the application development based on the received request;
recommending one or more service providers in each of the plurality of service categories based on the received request; and
creating the API for each of the recommended one or more service providers.

16. The computer readable storage medium of claim 15, wherein predicting the plurality of service categories required for the application development based on the received request comprises:
inputting the request from the customer to a Natural Language Processing (NLP) model to identify a plurality of inputs;
processing the plurality of inputs and historical data to a machine learning model; and
predicting the plurality of service categories required for the application development based on an output of the machine learning model.

17. The computer readable storage medium of claim 15, wherein recommending the one or more service providers in each of the plurality of service categories comprises:
identifying a customer profile using one or more sources, wherein the customer profile includes a location of the customer, a financial rating of the customer, and other details of the customer;
processing the customer profile and historical data to a machine learning model; and
recommending the one or more service providers in each of the plurality of service categories based on an output of the machine learning model.

18. The computer readable storage medium of claim 17, wherein creating the API for each of the recommended one or more service providers comprises:
retrieving the customer profile from a database;
estimating one or more input fields based on the retrieved customer profile and the recommended one or more service providers; and
creating the API based on the estimated one or more input fields.

19. The computer readable storage medium of claim 15, further comprises sending a request to the recommended one or more service providers via the created API, wherein the request to the recommended one or more service providers is sent to create an account for the customer in the recommended one or more service providers.

20. The computer readable storage medium of claim 19, further comprises:
integrating the one or more recommended service providers in the application under development using the customer account created at the recommended one or more service providers;
retrieving one or more documents related to each of the integrated one or more service providers; and
generating at least one consolidated document for the customer based on the retrieved one or more documents.
